(19) United States
(12) Patent Application Publication
(10) Pub. No.: US 2015/0006727 A1
(43) Pub. Date: Jan. 1, 2015

(54) METHOD AND APPARATUS FOR RESTRICTING USE OF AN ELECTRONIC DEVICE

(71) Applicant: Samsung Electronics Co., Ltd., Gyeonggi-do (KR)

(72) Inventors: Daesoo Park, Gyeongsangbuk-do (KR); Mangun Hur, Daegu (KR); Jongphil Lee, Daegu (KR); Jinwoo Lee, Gyeongsangbuk-do (KR)

(21) Appl. No.: 14/316,234

(22) Filed: Jun. 26, 2014

(30) Foreign Application Priority Data
Jun. 26, 2013 (KR) 10-2013-0073726

(51) Int. Cl. H04L 12/24

(52) U.S. Cl. CPC H04L 41/50
USPC 709/225

(57) ABSTRACT

A method and apparatus that can restrict use of an electronic device in a specific region is provided. The method includes detecting a triggering event initiating operation of an electronic device; obtaining, upon detection of the triggering event, identification information related to the electronic device; comparing the identification information with a preset list; and enforcing usage restriction of the electronic device when the identification information is present on the preset list.

### PRIORITY

This application claims priority under 35 U.S.C. §119(a) to Korean Patent Application Serial No. 10-2013-0073726, which was filed in the Korean Intellectual Property Office on Jun. 26, 2013, the entire disclosure of which is hereby incorporated by reference.

### BACKGROUND OF THE INVENTION

1. Field of the Invention

The present invention relates generally to restricting use of an electronic device. More particularly, the present invention relates to a method and apparatus that restricts use of an electronic device in a specific region.

2. Description of the Related Art

Recent advances in digital technologies have enabled development of various types of electronic devices supporting communication and personal information processing, such as mobile communication terminals, Personal Digital Assistants (PDA), electronic notes, smartphones, and tablet computers. High-end electronic devices have evolved into mobile convergence devices supporting heterogeneous functions having originated from distinct fields. For example, such an electronic device may support various functions related to calls (e.g., voice calls and video calls), messages (Short Message Service (SMS), Multimedia Message Service (MMS) and electronic mail), navigation, documents (memos and office data), image capture, broadcast reception and display, media playback (video and music), Internet, instant messengers, and Social Networking Services (SNS).

An electronic device may be equipped with a Subscriber Identity Module (SIM) card or a Universal Subscriber Identity Module (USIM). Here, the SIM card or USIM is a smart card that includes a microprocessor and memory chip. Such a smart card may be used to store personal subscription information (such as a phone number, a password and billing information) and network subscription information, which may be loaded while the electronic device is operated to receive a mobile communication service from a mobile communication network.

For an electronic device configured to include a smart card, a user cannot use the electronic device to receive calls and additional services (except for emergency calls) without a smart card. When a smart card is installed in an electronic device configured to include a smart card, the electronic device may be conveniently used to receive calls and additional services.

An electronic device configured to include a smart card may be used in any region or nation. Hence, electronic devices purchased in subsidized countries (e.g. European nations) may be used in non-subsidized countries (e.g. China) through, for example, smuggling. That is, electronic devices sold in one region may be carried into another region for commercial use through abnormal distribution. This may disturb marketing strategies of telecoms carriers or network operators.

### SUMMARY OF THE INVENTION

Aspects of the present invention are to address at least the above mentioned problems and/or disadvantages and to provide at least the advantages described below. Accordingly, an aspect of the present invention is to provide a method and apparatus that can restrict use of an electronic device in a designated region.

In accordance with an aspect of the present invention, a method for utilizing an electronic device is provided. The method includes detecting a triggering event initiating operation of the electronic device; obtaining, upon detection of the triggering event, identification information related to the electronic device; comparing the identification information with a preset list; and enforcing usage restriction of the electronic device according to the comparison result.

In accordance with another aspect of the present invention, an electronic device is provided. The electronic device includes a wireless communication unit which supports wireless communication with a network; a storage unit which stores a preset list; and a control unit which performs a process of obtaining identification information upon detection of a triggering event for operation initiation, and enforcing usage restriction of the electronic device when the identification information is present on the preset list.

In accordance with another aspect of the present invention, a computer readable storage medium is provided. The computer readable storage medium stores a program that detects a triggering event of an electronic device, obtains identification information in response to detection of the triggering event, compares the identification information with a preset list, and enforces usage restriction of the electronic device when the identification information is present on the preset list.

Hereinabove, the features and advantages of the present invention are described in a relatively broad perspective to help those skilled in the art understand the present invention. Other features and advantages constituting the subject matter of the present invention will be more apparent from the following detailed description.

In a feature of the present invention, the method and apparatus may restrict use of an electronic device in a particular region or country. According to various embodiments of the present invention, an electronic device may embed a function that can restrict usage of the electronic device on a region basis. Hence, when an electronic device purchased in one region such as a European nation is distributed in another region such as China or Russia, it is possible to restrict usage of the electronic device. Accordingly, it is possible to prevent distribution of electronic devices in a region or nation disallowing use of electronic devices, and it is possible to restrict usage of electronic devices in such a region.

Various embodiments of the present invention may be implemented in environments in which usage of electronic devices can be restricted on a region basis, contributing to enhancement of marketing strategies and competitiveness of operators. Various embodiments of the present invention may be implemented in a variety of portable consumer devices such as mobile communication devices, smartphones and tablet computers, and in various electronic devices and appliances supporting data processing (e.g. operation blocking).

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram of an electronic device according to an embodiment of the present invention;

FIG. 2 is a flowchart of a method for restricting use of an electronic device according to an embodiment of the present invention;

FIG. 3 is a flowchart of a smart-card based method for restricting use of an electronic device according to an embodiment of the present invention;

FIG. 4 is a flowchart of a network based method for restricting use of an electronic device according to an embodiment of the present invention; and

FIG. 5 is a flowchart of a method for restricting use of an electronic device according to an embodiment of the present invention.

### DETAILED DESCRIPTION OF EMBODIMENTS OF THE PRESENT INVENTION

The following description with reference to the accompanying drawings is provided to assist in a comprehensive understanding of various embodiments of the present invention as defined by the claims and their equivalents. It includes various specific details to assist in that understanding but these are to be regarded as merely examples. Accordingly, those of ordinary skill in the art will recognize that various changes and modifications of the embodiments described herein can be made without departing from the scope and spirit of the present invention. The same reference symbols are used throughout the drawings to refer to the same or like parts. Descriptions of well-known functions and constructions may be omitted for clarity and conciseness.

According to various embodiments of the present invention, it is possible to restrict usage of an electronic device on a per region basis and it is also possible to cause the electronic device to enforce region-based usage restriction by itself.

In various embodiments of the present invention, an electronic device may be any electronic appliance having an Application Processor (AP), Graphics Processing Unit (GPU) and Central Processing Unit (CPU), such as an information and communication device, multimedia device or applied device.

According to various embodiments of the present invention, use of an electronic device may be restricted on a per region basis. Hence, once an electronic device is sold in one region, the electronic device can be prevented from being illegitimately used in another region.

According to various embodiments of the present invention, usage restriction of an electronic device can be enforced on the basis of a smart card or a network.

In various embodiments of the present invention, it is possible to restrict usage of an electronic device configured to embed a smart card in a designated region according to preset information.

According to various embodiments of the present invention, an electronic device stores and manages a variety of information usable for region-based usage restriction (for example, information on forbidden smart cards, country information, network information, cell information, region information, base station information, and operator information) as a blacklist. The electronic device may obtain identification information such as smart card information or network information from an installed smart card, a connected network or another electronic device, compare the obtained identification information with the blacklist, and continue normal processing or enforce usage restriction according to the comparison result. Here, usage restriction may be enforced by deactivating the smart card. When the obtained identification information is present on the blacklist, the electronic device may enforce usage restriction in the current region. The above verification may be performed when the electronic device is booted or when the electronic device attempts network access.

In various embodiments of the present invention, a smart card may be an external storage medium installable in an electronic device through a given internal interface. The smart card may store a variety of smart card information and may include a SIM card or USIM card.

In various embodiments of the present invention, smart card information may be information usable for identifying a smart card such as country information, operator information, and subscriber information. In particular, smart card information may include information usable for determining whether to permit usage of an electronic device. For example, International Mobile Subscriber Identity (IMSI), Integrated Circuit Card Identity (ICCID), International Mobile Equipment Identity (IMEI), Service Provider Name (SPN) and the like may be included in the smart card information.

In various embodiments of the present invention, network information may be information usable for identifying a network to which an electronic device may connect at the current location. In particular, network information may include information usable for determining whether to permit usage of the electronic device. For example, network information may include Public Land Mobile Network (PLMN) information, cell information such as cell ID, and the like.

Next, a description is given of the configuration and operation of an electronic device with reference to the drawings. However, the configuration and operation thereof are not limited to or by the following description, and various changes and modifications are possible on the basis of the following description.

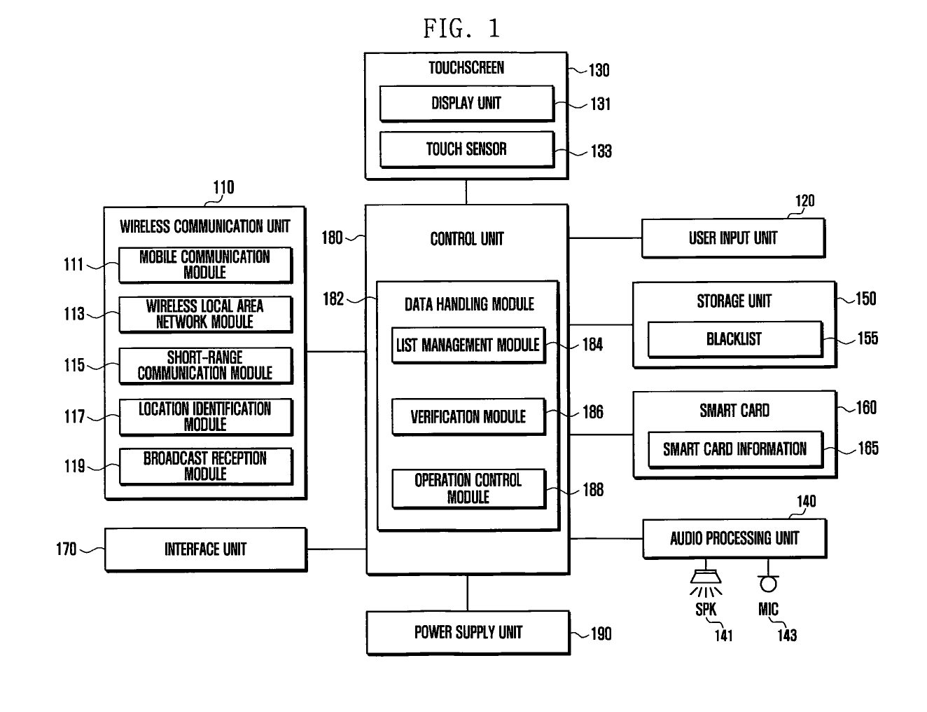

FIG. 1 is a block diagram of an electronic device according to an embodiment of the present invention.

Referring to FIG. 1, the electronic device may include a wireless communication unit 110, a user input unit 120, a touchscreen 130, an audio processing unit 140, a storage unit 150, a smart card 160, an interface unit 170, a control unit 180, and a power supply unit 190. In various embodiments, the electronic device may further include one or more units not shown in FIG. 1, and one or more units of the electronic device shown in FIG. 1 may be removed or replaced. For example, when the electronic device does not support a broadcast reception and playback function, the broadcast reception module 119 of the wireless communication unit 110 may be omitted.

The wireless communication unit 110 may include one or more modules that support wireless communication between the electronic device and a wireless communication system or between the electronic device and another electronic device. For example, in the embodiment illustrated in FIG. 1, the wireless communication unit 110 includes a mobile communication module 111, a wireless local area network (WLAN) module 113, a short-range communication module 115, a location identification module 117, and a broadcast reception module 119.

The mobile communication module 111 sends and receives radio signals to and from at least one of a base station, an external terminal, and a server (such as an integration server, provider server, content server, Internet server or cloud server) on a mobile communication network. The radio signals may carry various types of data relating to voice calls, video calls, and text or multimedia messages. In particular, the radio signals may carry information on a blacklist for restricting usage of the electronic device in a designated region.

The WLAN module 113 may be used to wirelessly access the Internet and to establish a WLAN link to another electronic device. The WLAN module 113 may be a built-in module or a removable module. Wireless Internet access may be achieved through Wi-Fi, Wireless broadband (WiBro), Worldwide Interoperability for Microwave Access (WiMAX) and High Speed Downlink Packet Access (HSDPA). When a WLAN link to a different electronic device is established, the WLAN module 113 sends and receives various data to and from the different electronic device according to user selection. The WLAN module 113 may be always on or may be turned on and off according to user settings or user input.

The short-range communication module 115 is used to support short-range communication. Short-range communication may be provided through Bluetooth, Bluetooth low energy (BLE), Radio Frequency Identification (RFID), Infrared Data Association (IrDA), Ultra Wideband (UWB), ZigBee, and Near Field Communication (NFC). When a short-range communication link to a different electronic device is established, the short-range communication module 115 sends and receives various data to and from the different electronic device according to user selection. The short-range communication module 115 may be always on or may be turned on and off according to user settings or user input.

The location identification module 117 is used to identify the location of the electronic device. A representative example of the location identification module 117 is a Global Positioning System (GPS) module. The location identification module 117 computes the latitude, longitude and altitude of the current location by applying triangulation to distance and time information received from three or more base stations. The location identification module 117 also identifies the current location by use of signals received in real time from three or more satellites. Location information may be obtained in various ways.

The broadcast reception module 119 receives a broadcast signal (e.g. a TV broadcast signal, radio broadcast signal or data broadcast signal) and associated information (e.g. information regarding broadcast channels, broadcast programs and broadcast service providers) from an external broadcasting server through a broadcast channel (e.g. satellite channel or terrestrial channel).

The user input unit 120 generates an input signal for controlling the electronic device corresponding to user manipulation. The user input unit 120 may include a keypad, dome switch, touchpad (resistive or capacitive), jog wheel, jog switch, and a sensor (such as a voice sensor, proximity sensor, illumination sensor, acceleration sensor, gyro sensor, motion sensor, or geomagnetic sensor). The user input unit 120 may include buttons formed on the exterior of the electronic device and virtual buttons on a touch panel. The user input unit 120 receives user input for operating the electronic device (manipulation or network access) and generates an input signal corresponding to the user input.

The touchscreen 130 is an input/output device supporting both an input function and a display function, and includes a display unit 131 and a touch sensor 133. For example, when a user touch event is detected by the touch sensor 133 in a state wherein a screen (e.g. application screen, call handling screen, instant messenger screen, gaming screen, or gallery screen) is displayed on the display unit 131, the touchscreen 130 sends an input signal corresponding to the touch event to the control unit 180, which then identifies the touch event and controls an operation according to the touch event.

The display unit 131 displays or outputs information processed by the electronic device. For example, when the electronic device is in a call handling mode, the display unit 131 displays a user interface (UI) or graphical user interface (GUI) for call handling. When the electronic device is in a video call mode or capture mode, the display unit 131 outputs a UI or GUI for displaying received or captured images. In particular, the display unit 131 displays a notification indicating prohibition of use of the electronic device under control of the control unit 180. The display unit 131 displays the screen in a landscape mode or portrait mode and switches between landscape mode and portrait mode according to rotation or placement of the electronic device.

The display unit 131 may be embodied in one or more display techniques based on liquid crystal display (LCD), thin film transistor liquid crystal display (TFT-LCD), light emitting diodes (LED), organic light emitting diodes (OLED), active matrix OLEDs (AMOLED), flexible display, bendable display, and 3D display. The display unit 131 may also use a transparent display technology which allows the display unit 131 to be seen from the outside.

The touch sensor 133 may be placed on the display unit 131 and senses user input of touching the surface of the touchscreen 130 or hovering thereon. When user input is detected on the surface of the touchscreen 130, the touch sensor 133 generates an input signal corresponding to the user input and sends the input signal to the control unit 180, which then performs a function according to the area in which the user input is generated.

The touch sensor 133 converts a pressure change or capacitance change detected at a site of the display unit 131 into an electrical signal. The touch sensor 133 senses the position and area of user touch input (or hovering input) and senses pressure caused by touch input according to a touch technique employed. Upon detection of user input, the touch sensor 133 sends a corresponding electrical signal to a touch controller (not shown). The touch controller processes the received electrical signal and sends data corresponding to the processed result to the control unit 180. The control unit 180 identifies the touch point on the touchscreen 130 and the like.

The audio processing unit 140 sends an audio signal from the control unit 180 to a speaker 141 and sends an audio signal such as a voice signal from a microphone 143 to the control unit 180. Under control of the control unit 180, the audio processing unit 140 converts voice or audio data into an audio signal and output the audio signal through the speaker 141 and converts an audio signal such as a voice signal from the microphone 143 into a digital signal and sends the digital signal to the control unit 180.

The speaker 141 is used to output audio data received through the wireless communication unit 110 or stored in the storage unit 150 during call handling, instant messaging, sound or video recording, speech recognition, broadcast reception, media playback (music or video), or image capture. The speaker 141 may also be used to output sound effects related to functions being executed (e.g. call reception, call placement, image capture and content playback).

The storage unit 150 stores programs for processing and controls operations of the control unit 180 and temporarily or semi-permanently stores input/output data such as contact information, documents, captured image data, messages, instant messages, media content (audio, video and images), blacklists, lists, and identification information.

In particular, the storage unit 150 stores a blacklist 155 containing, at a minimum, identification information to restrict usage of the electronic device in a designated region. For example, for usage restriction on a region basis, a variety of information, such as information on countries in which usage is prohibited, operator information, smart card information, network information, cell information, region information and base station information, may be registered in the blacklist 155 and maintained. The blacklist may be set by default at the time of manufacture and may be managed or updated by the service provider through Over-The-Air programming (OTA) or Firmware Over-The-Air (FOTA).

The storage unit 150 stores information setting schemes for usage restriction of the electronic device. In accordance with the present invention, usage restriction of the electronic device is enforced using identification information of the smart card (smart-card based scheme), using identification information of a network (network based scheme), and using both a smart card and network (composite scheme). Such setting information may be configured by default at the time of manufacture or be configured according to user settings.

The storage unit 150 temporarily or semi-permanently stores an operating system (OS) of the electronic device, programs supporting input and display operations of the touchscreen 130, a program for list management (update, delete, add or the like), a program for comparing list information with identification information, a program permitting or restricting usage of the electronic device according to the comparison result, and data generated during program execution.

The storage unit 150 includes one or more of various types of storage media, such as flash memory, hard disk, multimedia or other memory card (micro, Secure Digital Card (SD) or eXtream Digital Card (XD), Dynamic Random Access memory (DRAM), Static Random Access Memory (SRAM), Read Only Memory (ROM), Programmable Read-Only Memory (PROM), Electrically Erasable Programmable Read-Only Memory (EEPROM), Magnetic Memory (MRAM), magnetic disk, and optical disc. The storage unit 150 functions in cooperation with a Web storage over the Internet.

The smart card 160 may be an external storage medium installable in the electronic device through a given internal interface. In accordance with the present invention, the smart card 160 may be a SIM card, USIM card or the like. The smart card 160 stores smart card information 165 for self-identification. In various embodiments, the smart card information 165 may be any information usable for self-identification such as country information, operator information, and subscriber information. The smart card information 165 may be any information usable for determining whether to permit usage of the electronic device. For example, the smart card information 165 may include IMSI, ICCID, IMEI, SPN and the like. The smart card 160 may have a format of a full-size smart card, mini smart card, micro smart card, nano smart card, and embedded smart card.

The interface unit 170 is used to connect an external appliance to the electronic device. The interface unit 170 is used to receive data or power from an external appliance and to send internal data to the external appliance. For example, the interface unit 170 includes a wired/wireless headset port, charger port, wired/wireless data port, memory card port, port for a device with an identification module, audio input/output port, video input/output port, and earphone port.

The control unit 180 controls the overall operation of the electronic device. For example, the control unit 180 controls operations related to voice communication, data communication, and video communication. In particular, the control unit 180 includes a data handling module 182 to handle operations related to usage restriction of the electronic device. The data handling module 182 may be an internal entity of the control unit 180 or an entity separate therefrom. The data handling module 182 includes a list management module 184, a verification module 186 and an operation control module 188.

In the control unit 180, the list management module 184 manages the blacklist 155. For example, the list management module 184 updates the blacklist 155 according to an operator request by modifying, adding or deleting a specific entry of the blacklist 155. The blacklist 155 may be updated by the operator through OTA or FOTA or may be updated through wired connection between the electronic device and an operator management server.

The verification module 186 checks whether the blacklist 155 is present in the storage unit 150 in response to a triggering event. In accordance with the present invention, a triggering event may be generated by booting the electronic device or by a network access attempt made after network change. If the blacklist 155 is present in the storage unit 150, the verification module 186 obtains at least one of smart card information 165 and network information as identification information according to the usage restriction scheme employed. Thereafter, the verification module 186 compares the obtained identification information with the blacklist 155 to determine whether the identification information is present on the blacklist 155.

Upon determining that the identification information is not present on the blacklist 155, the operation control module 188 permits the electronic device to operate normally. Upon determining that the identification information is present on the blacklist 155, the operation control module 188 restricts use of the electronic device by deactivating the smart card 160. When usage restriction is enforced, the operation control module 188 controls an operation to display a usage restriction notification.

Control operations of the control unit 180 will be described in more detail below with reference to the drawings.

In addition, the control unit 180 controls regular operations of the electronic device. For example, when an application is executed, the control unit 180 controls application execution and screen display for the application. The control unit 180 receives an input signal corresponding to a touch event generated on the input interface (e.g., the touchscreen 130) and control function execution according to the input signal. The control unit 180 also controls transmission and reception of various data carried out through wired or wireless communication.

The power supply unit 190 supplies power from an external or internal power source to the individual components of the electronic device under control of the control unit 180.

As described above, usage restriction of the electronic device may be implemented through the list management module 184 that manages the blacklist 155 provided by the operator, the verification module 186 that determines whether to enforce usage restriction in response to a triggering event, and the operation control module 188 that permits normal usage or enforces usage restriction according to the determination result. Here, the list management module 184, the verification module 186 and the operation control module 188 may be computer-implemented modules. The verification module 186 compares identification information obtained from at least one of the smart card 160 and the network with the blacklist 155 determines to enforce usage restriction if the obtained identification information is present on the blacklist 155, and determines to permit normal usage if the obtained identification information is not present on the blacklist 155.

According to various embodiments of the present invention, the electronic device may be any electronic appliance having an Application Processor (AP), Graphics Processing Unit (GPU) and Central Processing Unit (CPU), such as an information and communication device, multimedia device or applied device. For example, the electronic device may be a mobile communication terminal based on communication protocols supporting various communication systems, a smartphone, a tablet computer, a portable multimedia player (PMP), a media player, such as an MP3 player, a portable game console, and a personal digital assistant (PDA).

Various embodiments of the present invention can be implemented using hardware, software or a combination thereof. Software implementation can be stored in a storage medium readable by a computer or a similar device. Hardware implementation may be achieved using at least one of an Application Specific Integrated Circuit (ASIC), Digital Signal Processor (DSP), Digital Signal Processing Device (DSPD), Programmable Logic Device (PLD), Field Programmable Gate Array (FPGA), processor, controller, micro-controller, microprocessor, and electric unit realizing a specific function.

Some embodiments of the present invention may be directly implemented by the control unit 180. Procedures and functions described in the specification may be implemented by software modules (e.g. the list management module 184, verification module 186 and operation control module 188). Each software module may perform one or more functions or operations described in the specification.

The storage medium may be a computer readable storage medium storing a program that detects a triggering event initiating operation of the electronic device, obtains identification information for determining usage restriction in response to detection of the triggering event, compares the identification information with a preset blacklist, and enforces usage restriction of the electronic device if the identification information is present on the blacklist.

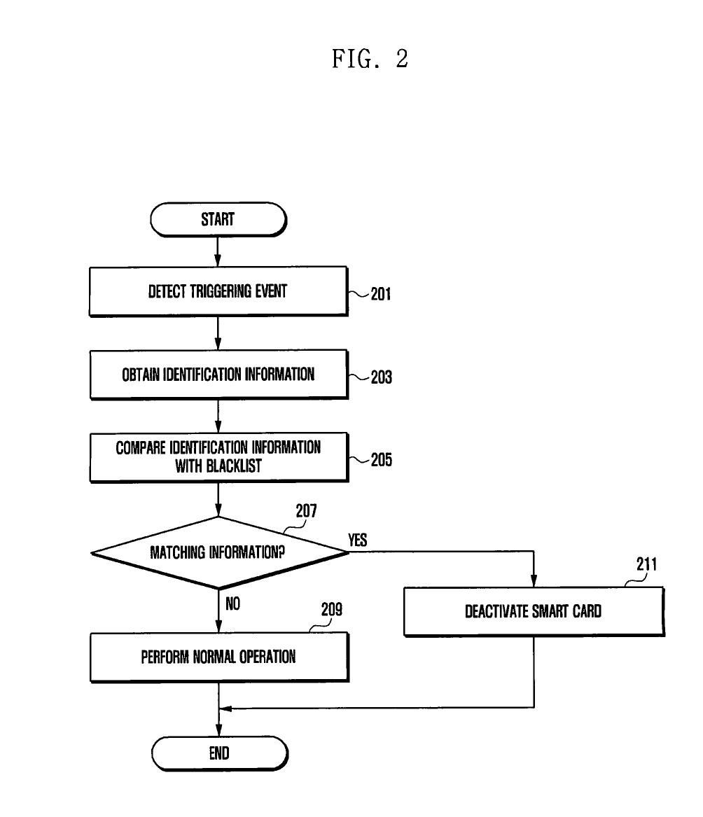

FIG. 2 is a flowchart of a method for restricting use of an electronic device according to an embodiment of the present invention.

Referring to FIG. 2, at step 201, the control unit 180 detects a triggering event initiating operation of the electronic device. Here, the triggering event may correspond to a user action for booting the electronic device. For example, when the user turns on the electronic device in which the smart card 160 is embedded, the control unit 180 may detect installation of the smart card 160 through a given interface and perform the boot operation. Alternatively, a triggering event may correspond to a new network access attempt made after occurrence of a network change due to movement between regions (e.g., countries) while the electronic device is operating or is in a usage restriction state.

Upon detection of the triggering event, at step 203, the control unit 180 obtains identification information. The identification information may be obtained from the smart card 160 installed in the electronic device or from a network to which an access attempt is made. The control unit 180 refers to preset configuration information for identification information and obtains identification information from the smart card 160 or a network according to the configuration information.

At step 205, the control unit 180 compares the obtained identification information with the blacklist 155 stored in the storage unit 150. At step 207, the control unit 180 checks whether the obtained identification information matches an entry of the blacklist 155. For example, the blacklist 155 may contain usage restriction information in connection with countries, smart cards, networks, cells, regions, base stations and network operators. Hence, the control unit 180 determines whether the obtained identification information matches an item of the blacklist 155.

If the obtained identification information does not match an item of the blacklist 155, the control unit 180 proceeds to step 209 at which the control unit 180 determines that the electronic device is in a region (e.g., country or cell) wherein usage thereof is allowed and performs normal operation. For example, the control unit 180 may normally boot the electronic device and remain in a standby state waiting for user input. The control unit 180 also performs a series of operations to connect to a network and remains in a state ready for network access.

If the obtained identification information matches an item of the blacklist 155 at step 207, the control unit 180 proceeds to step 211 at which the control unit 180 determines that the electronic device is in a region (e.g., country or cell) wherein usage thereof is not allowed and enforces usage restriction of the electronic device. For example, the control unit 180 deactivates the smart card 160, so that functions of the electronic device related to, for example, calls, messages, Wireless Application Protocol (WAP) and applications cannot be used or executed or network access is not allowed.

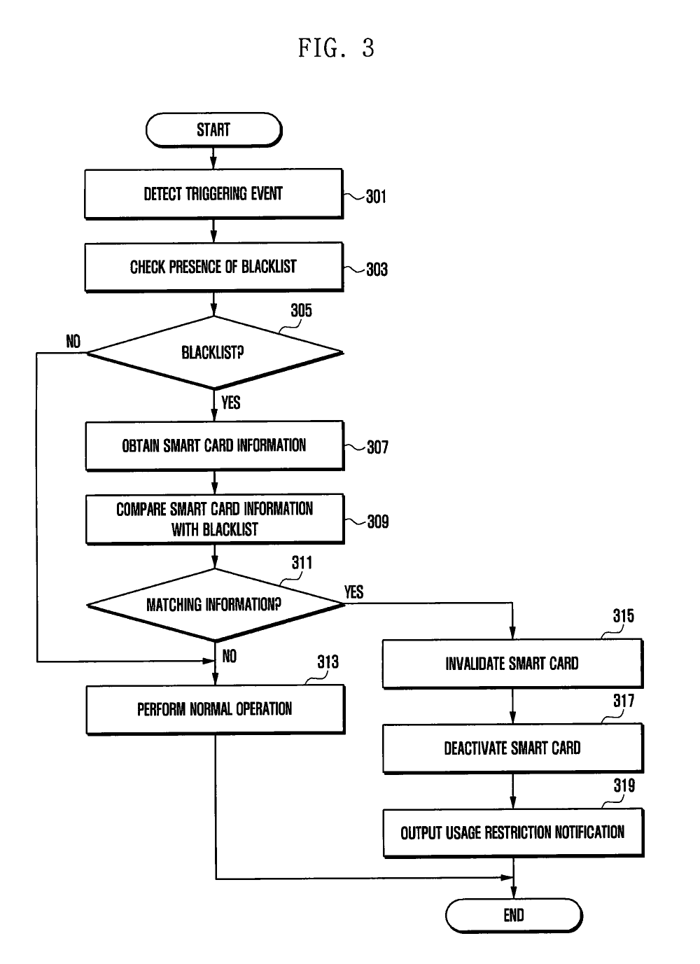

FIG. 3 is a flowchart of a smart-card based method for restricting use of an electronic device according to an embodiment of the present invention.

Referring to FIG. 3, at step 301, the control unit 180 detects a triggering event initiating operation of the electronic device. Here, the triggering event corresponds to a user action for booting the electronic device or to a network access attempt made after occurrence of a network change. In FIG. 3, it is assumed that the triggering event is caused by a user action of booting the electronic device and usage restriction of the electronic device is enforced on the basis of a smart card. However, the present invention is not limited thereto. Usage restriction may be enforced on the basis of a network after the triggering event is caused by a booting action.

Upon detection of the triggering event (e.g., booting action), at step 303, the control unit 180 checks a presence of a blacklist. At step 305, the control unit 180 checks whether a blacklist 155 is stored in the storage unit 150.

If a blacklist 155 is not stored in the storage unit 150, the control unit 180 proceeds to step 313 at which the control unit 180 determines that the electronic device is in a region (e.g., country or cell) wherein usage thereof is allowed and performs normal operation. For example, the control unit 180 may normally boot the electronic device and remain in a standby state waiting for user input.

If a blacklist 155 is stored in the storage unit 150 at step 305, the control unit 180 proceeds to step 307 at which the control unit 180 obtains smart card information from the smart card 160. Here, smart card information may be information usable for identifying a smart card such as country information, operator information, and subscriber information. In particular, smart card information may include information usable for determining whether to permit usage of the electronic device. For example, IMSI, ICCID, IMEI, and SPN may be included in the smart card information.

At step 309, the control unit 180 compares the obtained smart card information with the blacklist 155 stored in the storage unit 150. At step 311, the control unit 180 checks whether the obtained smart card information matches an entry of the blacklist 155. The control unit 180 determines whether the smart card information matches one of various items in the blacklist 155.

If the obtained smart card information does not match an entry of the blacklist 155, the control unit 180 proceeds to step 313 at which the control unit 180 determines that the electronic device is in a region (e.g., country or cell) in which usage thereof is allowed and performs normal operation. For example, the control unit 180 may normally boot the electronic device and remain in a standby state waiting for user input.

If the obtained smart card information matches an entry of the blacklist 155 at step 311, the control unit 180 proceeds to step 315 at which the control unit 180 determines that the electronic device is in a region (e.g., country or cell) in which usage thereof is not allowed and invalidates the smart card 160 installed in the electronic device. At step 317, the control unit 180 deactivates the smart card 160, so that functions of the electronic device related to, for example, calls, messages, WAP and applications cannot be used or executed.

At step 319, the control unit 180 outputs a usage restriction notification. For example, the control unit 180 notifies the user by outputting a notification indicating that the smart card 160 installed in the electronic device is an invalid smart card or that use of the electronic device is not allowed in the current region (e.g., country, cell or the like) on the display unit 131.

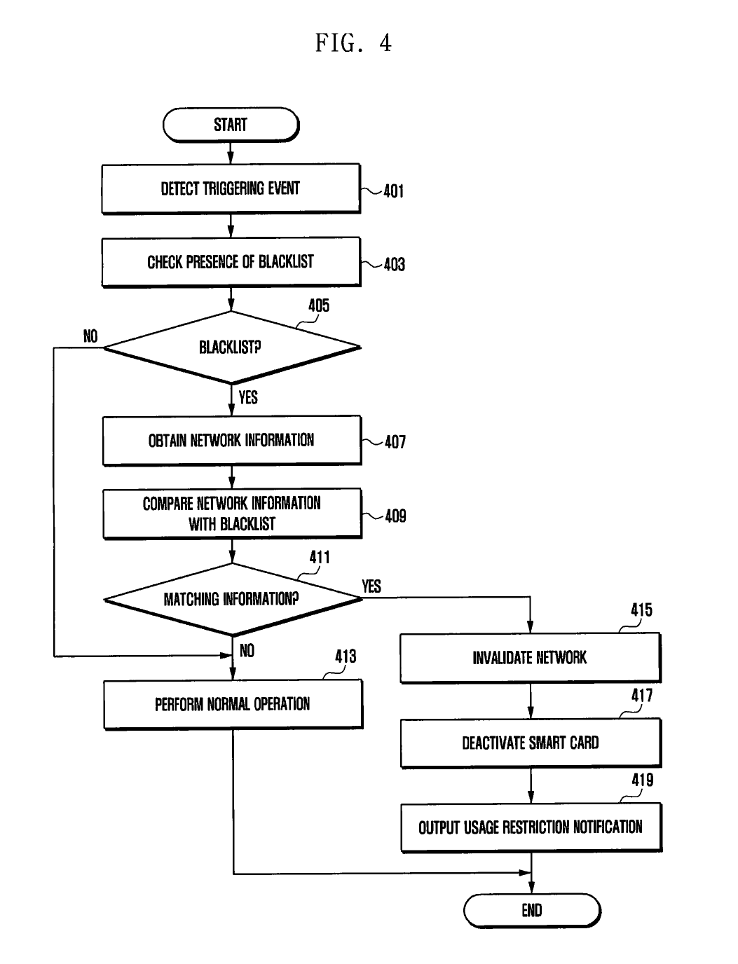

FIG. 4 is a flowchart of a network based method for restricting use of an electronic device according to an embodiment of the present invention.

Referring to FIG. 4, at step 401, the control unit 180 detects a triggering event initiating operation of the electronic device. Here, the triggering event may correspond to a user action for booting the electronic device or to a network access attempt made after network change. In FIG. 4, it is assumed that the triggering event is caused by a network access attempt made after occurrence of a network change and usage restriction of the electronic device is enforced on the basis of a network. However, the present invention is not limited thereto. Usage restriction may be enforced on the basis of a smart card after the triggering event is caused by a network access attempt.

Upon detection of the triggering event (network access attempt), at step 403, the control unit 180 checks a presence of a blacklist. At step 405, the control unit 180 checks whether a blacklist 155 is stored in the storage unit 150.

If a blacklist 155 is not stored in the storage unit 150, the control unit 180 proceeds to step 413 at which the control unit 180 determines that the electronic device is in a region (e.g., country or cell) wherein usage thereof is allowed and performs normal operation. For example, the control unit 180 connects to a network operating in the current region, performs registration in the network, and remains in a state ready for network access.

If a blacklist 155 is stored in the storage unit 150 at step 405, the control unit 180 proceeds to step 407 at which the control unit 180 obtains network information from the network operating in the current region. Here, network information may be information usable for identifying a network to which an electronic device may connect at the current location. In particular, network information may include information usable for determining whether to permit usage of the electronic device. For example, network information may include PLMN information and cell information.

At step 409, the control unit 180 compares the obtained network information with the blacklist 155 stored in the storage unit 150. At step 411, the control unit 180 checks whether the obtained network information matches an entry of the blacklist 155. The control unit 180 determines whether the network information matches one of various items in the blacklist 155.

If the obtained network information does not match an entry of the blacklist 155, the control unit 180 proceeds to step 413 at which the control unit 180 determines that the electronic device is in a region (e.g., country or cell) in which usage thereof is allowed and performs normal operation. For example, the control unit 180 connects to the current network, registers with the network, and remains in a state ready for network access.

If the obtained network information matches an entry of the blacklist 155 at step 411, the control unit 180 proceeds to operation 415 at which the control unit 180 determines that the electronic device is in a region (e.g., country or cell) in which usage thereof is not allowed and invalidates the network to which an access attempt has been made. At step 417, the control unit 180 deactivates the smart card 160, so that functions of the electronic device related to, for example, calls, messages, WAP and applications cannot be used or executed.

At step 419, the control unit 180 outputs a usage restriction notification. For example, the control unit 180 notifies the user by outputting a notification indicating that the smart card 160 installed in the electronic device is an invalid smart card or that use of the electronic device is not allowed in the current region (e.g., country, cell or the like) on the display unit 131.

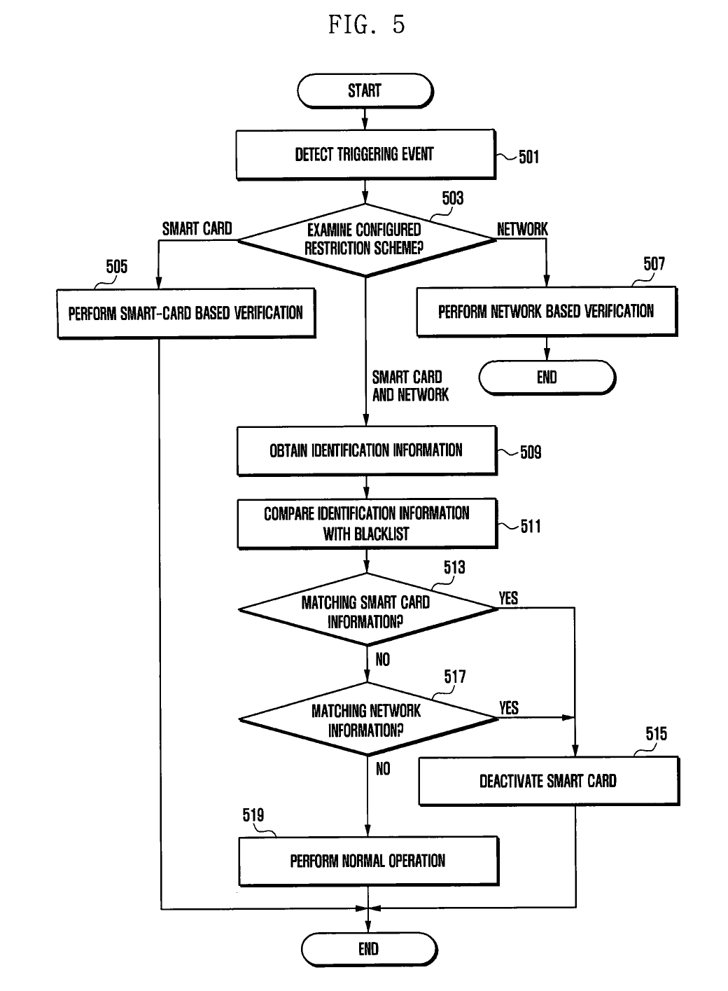

FIG. 5 is a flowchart of a method for restricting use of an electronic device according to an embodiment of the present invention.

Referring to FIG. 5, at step 501, the control unit 180 detects a triggering event initiating operation of the electronic device. Here, the triggering event may correspond to a user action for booting the electronic device or to a network access attempt made after occurrence of a network change.

Upon detection of the triggering event, at step 501, the control unit 180 checks the configured usage restriction scheme. Here, usage restriction may be enforced on the basis of a smart card, a network, and a combination thereof. The usage restriction scheme may be configured by default at the time of manufacture and may be changed by a service provider.

If the usage restriction scheme is configured on the basis of a smart card at step 503, the control unit 180 proceeds to step 505 at which the control unit 180 performs smart-card based verification. For smart-card based verification, as described in connection with FIG. 3, the control unit 180 obtains smart card information from the smart card 160 installed in the electronic device and determines whether to enforce usage restriction by comparing the smart card information with the blacklist 155. The control unit 180 performs normal operation or enforces usage restriction by deactivating the smart card 160 according to the comparison result.

If the usage restriction scheme is configured on the basis of a network at step 503, the control unit 180 proceeds to step 507 at which the control unit 180 performs network based verification. For network based verification, as described in connection with FIG. 4, the control unit 180 obtains network information from a network accessible at the current location and determines whether to enforce usage restriction by comparing the network information with the blacklist 155. The control unit 180 performs normal operation or enforces usage restriction by deactivating the smart card 160 according to the comparison result.

If the usage restriction scheme is configured on the basis of both a smart card and a network at step 503, the control unit 180 proceeds to step 509 at which the control unit 180 obtains identification information. Here, the control unit 180 may obtain smart card information from the smart card 160 installed in the electronic device or obtain network information from a network accessible at the current location as identification information.

At step 511, the control unit 180 compares the obtained identification information with the blacklist 155 stored in the storage unit 150. At step 513, the control unit 180 checks whether the obtained smart card information matches an entry of the blacklist 155. The control unit 180 determines whether the smart card information matches one of various items in the blacklist 155.

If the smart card information matches an entry of the blacklist 155 at step 513, the control unit 180 proceeds to step 515 at which the control unit 180 enforces usage restriction of the electronic device by deactivating the smart card 160.

If the smart card information does not match an entry of the blacklist 155 at step 513, the control unit 180 proceeds to step 517 at which the control unit 180 checks whether the obtained network information matches an entry of the blacklist 155. The control unit 180 determines whether the network information matches one of various items in the blacklist 155.

If the network information matches an entry of the blacklist 155 at step 517, the control unit 180 proceeds to step 515 at which the control unit 180 enforces usage restriction of the electronic device by deactivating the smart card 160.

If the network information does not match an entry of the blacklist 155, the control unit 180 proceeds to step 519 at which the control unit 180 performs normal operation of the electronic device.

As described above, in the event that the usage restriction scheme is configured on the basis of a combination of a smart card and a network, usage of the electronic device may be restricted when at least one of smart card information and network information is present on the blacklist 155 The electronic device may be normally operated when neither smart card information nor network information is present on the blacklist 155.

In various embodiments of the present invention, modules may be embodied in software, firmware, hardware or a combination thereof. Some or all modules may be combined into one entity without change in functions of the modules.

In various embodiments of the present invention, steps may be executed in sequence, by repetition, or in parallel. Some steps may be omitted or new steps may be added. Steps may be carried out by a corresponding module.

Various embodiments of the present invention may be implemented as computer programs and may be stored in various computer readable storage media. The computer readable storage media may store program instructions, data files, data structures, and combinations thereof. The program instructions may include instructions developed specifically for the present invention and widely known general-purpose instructions.

The computer readable storage media may include magnetic media such as a hard disk and floppy disk, optical media such as a Compact Disc Read Only Memory (CD-ROM) and Digital Versatile Disc (DVD), magneto-optical media such as a floptical disk, and memory devices such as a ROM, RAM and flash memory. The program instructions may include machine codes produced by compilers and high-level language codes executable through interpreters. Each hardware device may be replaced with one or more software modules to perform operations according to the present invention, and vice versa.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for utilizing an electronic device, the method comprising:
detecting a triggering event initiating operation of the electronic device;
obtaining, upon detection of the triggering event, identification information related to the electronic device;
comparing the identification information with a preset list; and
enforcing usage restriction of the electronic device according to the comparison result.

2. The method of claim 1, wherein detecting of the triggering event comprises detecting one of an action to boot the electronic device and a network access attempt made by the electronic device.

3. The method of claim 1, wherein the identification information comprises information on a smart card installed in the electronic device and information on a network to which the electronic device makes an access attempt.

4. The method of claim 1, wherein obtaining the identification information comprises examining a predetermined usage restriction scheme.

5. The method of claim 4, wherein obtaining the identification information comprises obtaining, when the configured usage restriction scheme is smart-card based, smart card information from a smart card installed on the electronic device.

6. The method of claim 4, wherein obtaining the identification information comprises obtaining, when the configured usage restriction scheme is network based, network information from a network.

7. The method of claim 4, wherein obtaining the identification information comprises obtaining, when the configured usage restriction scheme is composite based, smart card information from a smart card and obtaining network information from a network.

8. The method of claim 1, wherein comparing of the identification information comprises checking whether the identification information matches an entry of the preset list stored in a storage unit of the electronic device.

9. The method of claim 1, wherein enforcing the usage restriction comprises deactivating a smart card installed on the electronic device.

10. The method of claim 1, wherein the preset list is managed by a service provider through an over-the-air (OTA) or firmware over-the-air (FOTA) technique.

11. The method of claim 1, wherein the preset list is a blacklist that contains at least one type of identification information used for restricting usage of the electronic device in a specific region.

12. The method of claim 1, wherein usage restriction of the electronic device is enforced when the identification information is present on the preset list.

13. An electronic device comprising:
a wireless communication unit which supports wireless communication with a network;
a storage unit which stores a preset list; and
a control unit which performs a process of obtaining identification information upon detection of a triggering event for operation initiation, and enforcing usage restriction of the electronic device when the identification information is present on the preset list.

14. The electronic device of claim 13, wherein the control unit comprises:
a verification module that determines whether to enforce usage restriction in response to a triggering event; and
an operation control module that permits normal operation or enforces usage restriction according to the determination result.

15. The electronic device of claim 14, wherein the verification module determines to enforce usage restriction when identification information obtained from at least one of a smart card and a network is present on the preset list.

16. The electronic device of claim 14, wherein the control unit further comprises a list management module that manages the preset list provided by a service provider.

17. The electronic device of claim 13, wherein the preset list contains at least one type of identification information used for restricting usage of the electronic device in a specific region.

18. The electronic device of claim 13, wherein the obtained identification information is identification information used to determine whether to enforce usage restriction of the electronic device.

19. The electronic device of claim 13, wherein the preset list is managed by a service provider through an over-the-air (OTA) or firmware over-the-air (FOTA) technique.

20. A computer readable storage medium storing a program that detects a triggering event of an electronic device, obtains identification information in response to detection of the triggering event, compares the identification information with a preset list, and enforces usage restriction of the electronic device when the identification information is present on the preset list.
